(19) United States
(12) Patent Application Publication
(10) Pub. No.: US 2008/0106481 A1
(43) Pub. Date: May 8, 2008

(54) Dipole Antenna With Reduced Feedline Reverse Current

(75) Inventors: Zuo Hua Lin, Hsinch (TW); Wun Man Huang, Hsinchu (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Z-Com, Inc., Hsinchu (TW)

(21) Appl. No.: 11/556,821

(22) Filed: Nov. 6, 2006

(51) Int. Cl. H01Q 9/16

(52) U.S. Cl. 343/793

(57) ABSTRACT

A dipole antenna with reduced feedline reverse current is provided. A substrate includes a first surface and a second surface, with a feed aperture and a ground aperture penetrating through both the first and second surfaces. A radiator is configured on the first surface for receiving and transmitting wireless signals. A feeder configured on the second surface connects the radiator through the feed aperture. A ground portion with a main notch is configured on the second surface and connects the radiator through the ground aperture. A feedline passing the main notch has an end connecting to the feeder and the ground portion. The reverse current of the feed line is absorbed by the ground portion around the main notch.

### BACKGROUND OF THE INVENTION

1. Field of Invention

The present invention relates to a dipole antenna, and more particularly to a dipole antenna capable of reducing the feedline reverse current.

2. Related Art

Accompanying with the technology advancement, the development of wireless transmission system brings human life plentiful conveniences. One of the most significant components in a wireless transmission apparatus is the antenna. With the antenna configured on the wireless transmission apparatus, a transmitter may transform voltage or current signals into wireless signals and then broadcasts in the air as radiation. Similarly, the wireless signals in the air may be received by the antenna, transformed into voltage or current, and processed by the wireless transmission apparatus to complete wireless transmission.

Please refer to FIG. 1, an explanatory diagram illustrating the connection between a dipole antenna and a feedline in the prior art. The dipole antenna is a common antenna type. When the dipole antenna is configured in a wireless transmission apparatus, the feedline is required to transmit the current signals to the dipole antenna and the wireless signals will be sent out through the dipole antenna. One common type of the feedline is a coaxial cable 20. The coaxial cable 20 is an imbalance transmission line. When the coaxial cable 20 and the dipole antenna 10 is connected, an external conductor terminal of the coaxial cable 20 will have some current i₂ flow to the outer surface of the external conductor; wherein the current i₂ is the so-called reverse current. Therefore, the forward currents at the two ends of the dipole antenna 10 will be asymmetric (1₁≠i₁). Meanwhile, the overflowed reverse current i₂ will also resonates and radiates on the coaxial cable 20, which seriously influences the radiation pattern and impedance of the antenna.

Please refer to FIG. 2, which is a radiation pattern diagram in the prior art with experimental data at 2.45 GHz, Y-Z plane when no reverse current affects the dipole antenna; FIG. 3 is a radiation pattern diagram with experimental data at 2.45 GHz, Y-Z plane when the reverse current affects the dipole antenna in the prior art. Comparing FIG. 2 with FIG. 3, it is obvious that the reverse current seriously affects the radiation patterns of the dipole antenna and causes the inaccuracy of the anticipated radiation patterns. Moreover, the reverse current results in negative effects like the wire impedance instability and the circuit malfunction.

A common solution for aforesaid problems in the prior art is to add a metal pipe on the coaxial cable. This helps to improve the problems of the reverse current, yet other problems such as the cost of the metal pipe, the extra space needed to configure the metal pipe, and the metal pipe being incapable of unity shaping with the antenna, will come along instead.

### SUMMARY OF THE INVENTION

Accordingly, the present invention provides a dipole antenna capable of reducing the feedline reverse current without additional metal pipe.

The dipole antenna with reduced feedline reverse current according to the present invention comprises a substrate, a radiator, a feeder, a ground portion and a feedline.

The substrate includes a first surface, a second surface, a feed aperture and a ground aperture; wherein the feed aperture and the ground aperture both penetrating the first surface and the second surface.

The radiator is made of metal conductor, configuring on the first surface of the substrate for receiving and transmitting wireless signals. The feeder is made of metal conductor, configuring on the second surface of the substrate and connecting the radiator through the feed aperture.

The ground portion is also made of metal conductor, configuring on the second surface of the substrate, connecting the radiator through the ground aperture, and having a main notch. The main notch may be approximately rectangular, extending inwards from an edge of the second surface on the substrate.

The feedline passes through the main notch of the ground portion, with its central conductor (central line) connecting with the feeder and its external ground conductor connecting with the ground portion; wherein, the reverse current generated on the feedline may be absorbed by the ground portion around the main notch.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is an explanatory diagram illustrating the connection between a dipole antenna and a feedline in the prior art.

FIG. 2 is a radiation pattern diagram with experimental data at 2.45 GHz, Y-Z plane when no reverse current effects the dipole antenna in the prior art.

FIG. 3 is a radiation pattern diagram with experimental data at 2.45 GHz, Y-Z plane when the reverse current affects the dipole antenna in the prior art.

FIG. 4 is an explanatory diagram showing a first surface on a dipole antenna with reduced feedline reverse current according to the present invention.

FIG. 5 is an explanatory diagram showing a second surface on the dipole antenna with reduced feedline reverse current according to the present invention.

FIG. 6 shows the feed structure of the dipole antenna with reduced feedline reverse current according to the present invention.

FIG. 7 is a magnitude-frequency diagram with measured data of the return loss for the dipole antenna with reduced feedline reverse current according to the present invention.

FIG. 8 is a magnitude-frequency diagram with measured data of the VSWR (Voltage Standing Wave Ratio) for the dipole antenna with reduced feedline reverse current according to the present invention.

FIG. 9 is a radiation pattern diagram of the dipole antenna with reduced feedline reverse current according to the present invention with experimental data at 2.45 GHz, X-Y plane.

FIG. 10 is a radiation pattern diagram of the dipole antenna with reduced feedline reverse current according to the present invention with experimental data at 2.45 GHz, Y-Z plane.

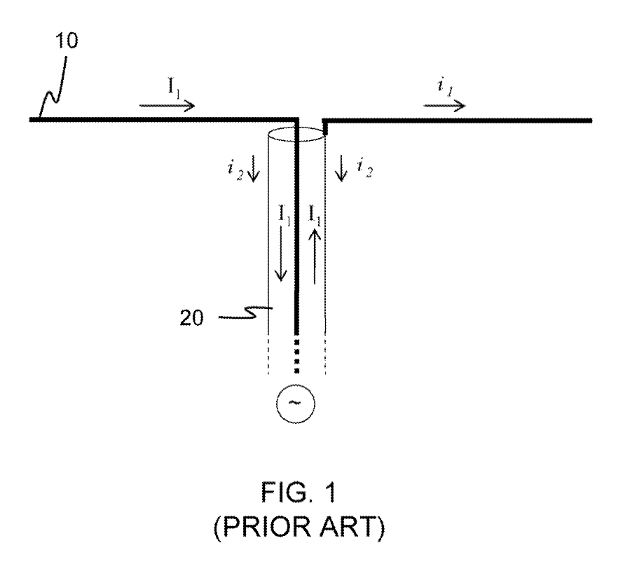

### DETAILED DESCRIPTION OF THE INVENTION

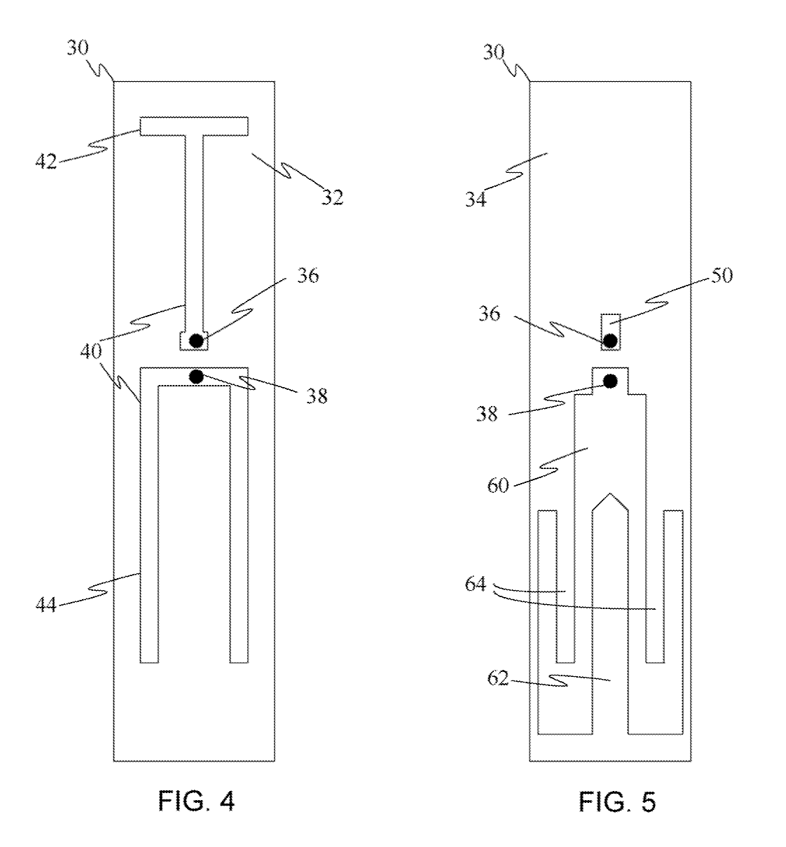

Please refer to FIG. 4 that shows an explanatory diagram showing a first surface on a dipole antenna with reduced feedline reverse current according to the present invention, and FIG. 5 that shows an explanatory diagram showing a second surface on the dipole antenna with reduced feedline reverse current according to the present invention. A substrate 30 includes a first surface 32 and a second surface 34, with a feed aperture 36 and a ground aperture 38 penetrating through both the first and second surfaces 32, 34. The first surface 32 is configured with a radiator 40 thereon for receiving and transmitting wireless signals. The second surface 34 is configured with a feeder 50 and a ground portion 60 with a main notch 62. The radiator 40, the feeder 50 and the ground portion 60 is made of metal conductor.

Referring to FIG. 4, the radiator 40 may be divided into a first radiation region 42 and a second radiation region 44; wherein the first radiation region 42 and the second radiation region 44 have to meet an electrical length of quarter wavelength. As long as the request for the electrical length of quarter wavelength is fulfilled, the first radiation region 42 and the second radiation region 44 may be any shapes. As shown in FIG. 4, in the present embodiment the first radiation region 42 is T-shaped and the second radiation region 44 is approximately a reverse-U shape.

The feed aperture 36 and the ground aperture 38 penetrates through both the first and second surfaces 32, 34 of the substrate 30. The feeder 50 may then connect with the first radiation region 42 of the radiator 40 through the feed aperture 36. And the ground portion 60 connects the second radiation region 44 of the radiator 40 through the ground aperture 38.

The ground portion 60 further includes auxiliary notches 64, corresponsive to the radiator 40 on the first surface 32. The reason why the ground portion 60 is configured with the auxiliary notches 64 is mainly because the antenna radiation pattern will be affected when the ground portion 60 on the second surface 34 and the radiator 40 on the first surface 32 are corresponsive to overlap each other. Therefore, the shape and location of the auxiliary notch 64 is designed to prevent the ground portion 60 and the radiator 40 from overlapping each other correspondingly and affecting the antenna radiation pattern.

As shown in FIG. 5, in the present embodiment the auxiliary notches 64 are located at the two lateral sides of the main notch 62, with their openings extending towards an opposite direction of the opening of the main notch 62. The second radiation region 44 on the first surface 32 is corresponsive to the auxiliary notch 64 on the second surface 34, thereby preventing from corresponding and overlapping the ground portion 60.

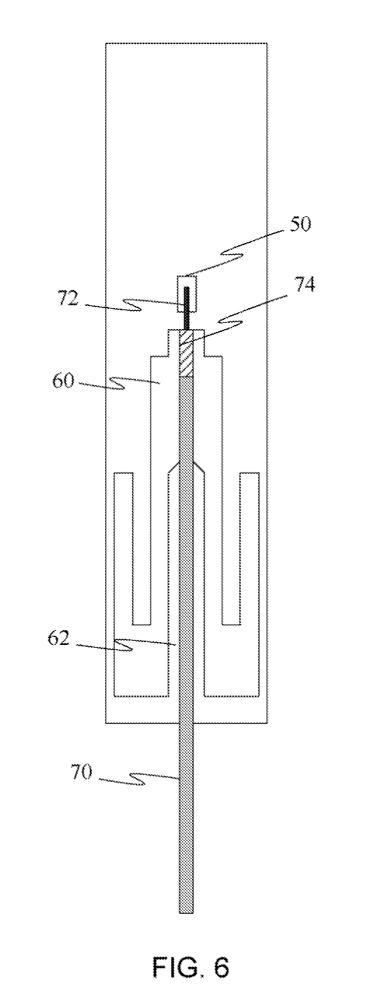

Please refer to FIG. 6, which shows the feed structure of the dipole antenna with a reduced feedline reverse current. The dipole antenna of the present invention further includes a feedline 70, mainly for feeding the voltage or current of the wireless transmission apparatus to the dipole antenna. The feedline 70 passes through the main notch 62 of the ground portion 60, with one end connecting with the feeder 50 and the ground portion 60. When the end of the feedline 70 is connected to the feeder 50 and the ground portion 60, the feeder 50 will be conductively connected with the first radiation region 42 of the radiator 40 through the feed aperture 36. The ground portion 60 is also connected conductively with the second radiation region 44 of the radiator 40 through the ground aperture 38.

The aforesaid the feedline 70 may be a coaxial cable that includes a central conductor 72 and an external ground conductor 74; wherein the external ground conductor 74 surrounds the central conductor 72. As shown in FIG. 6, the coaxial cable has one end pulled out with the central conductor 72 to connect with the feeder 50, and the external ground conductor 74 at the same end connects the ground portion 60. The other end of the coaxial cable passes the main notch 62 of the ground portion 60.

When the central conductor 72 is connected to the feeder 50, a forward current may be allowed to flow therein. However, as mentioned above, the coaxial cable is an imbalance transmission line. Therefore when the coaxial cable has the forward current flowing therein, partial current will flow outwards to the outside of the external ground conductor 74 and become the reverse current.

Nevertheless, in the present invention the external ground conductor 74 is connected with the ground portion 60, the ground portion 60 having the main notch 62 thereunder, and the coaxial cable passes the main notch 62. Such design allows the reverse current generated by the external ground conductor 74 to be absorbed by the ground portion 60 around the main notch 62.

The shape of the main notch 62 of the ground portion 60 has to meet two requirements. The first requirement is to allow the feedline 70 to pass through. The second requirement is the overall sum of the input impedances of the ground portion 60, the radiator 40 and the feeder 50 is approximately 50 ohm. As long as the two requirements are fulfilled, the main notch 62 of the ground portion 60 may be any shape. Therefore, the main notch 62 may be approximately rectangular, extending inwards from the edge of the second surface 34 on the substrate 30.

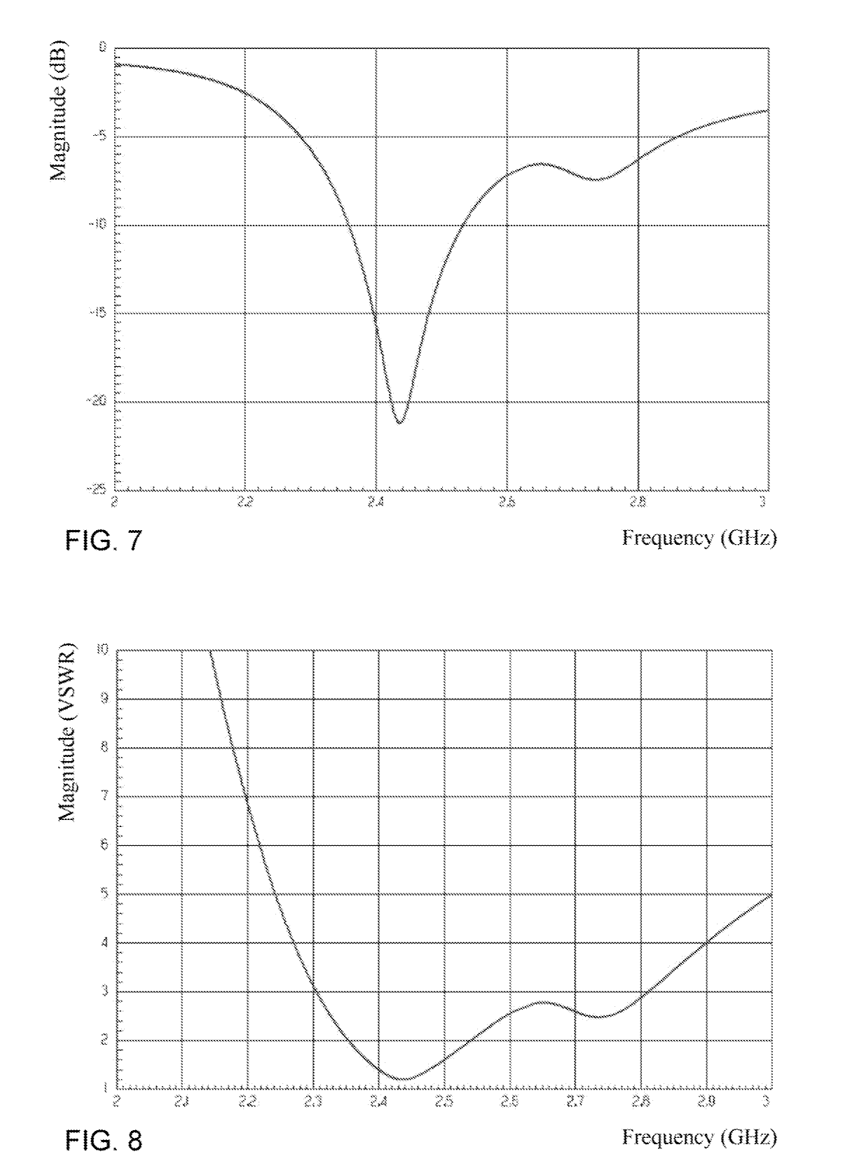

Eventually, the present invention provides actually measured return loss, VSWR and the radiation pattern diagrams for further explanation. Please refer to FIGS. 7-10, which illustrate the experimental data of the return loss, VSWR and radiation pattern obtained by proceeding various experimental tests on the dipole antenna with reduced feedline reverse current according to the present invention.

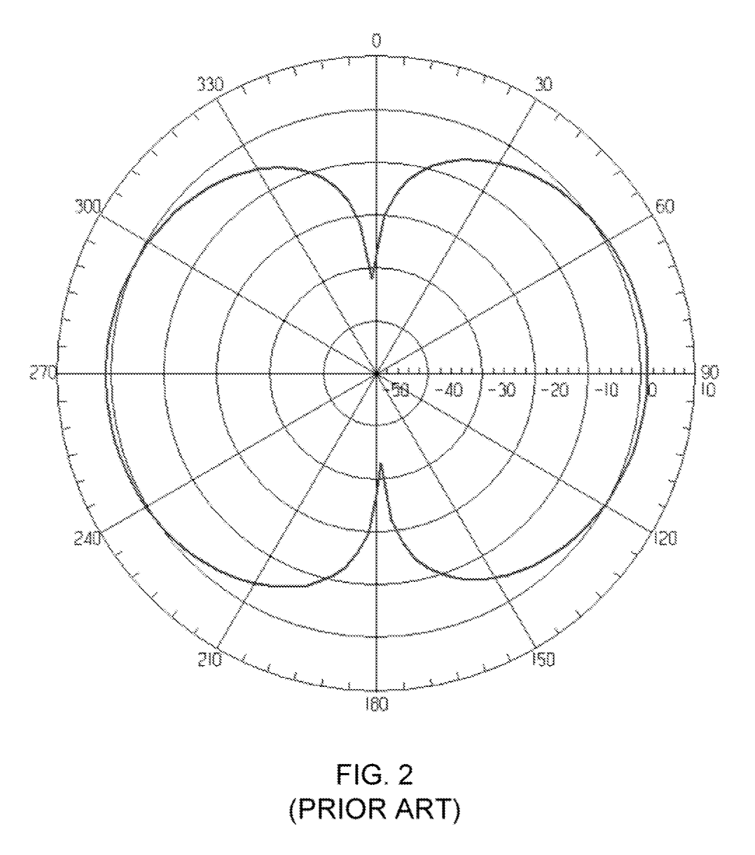

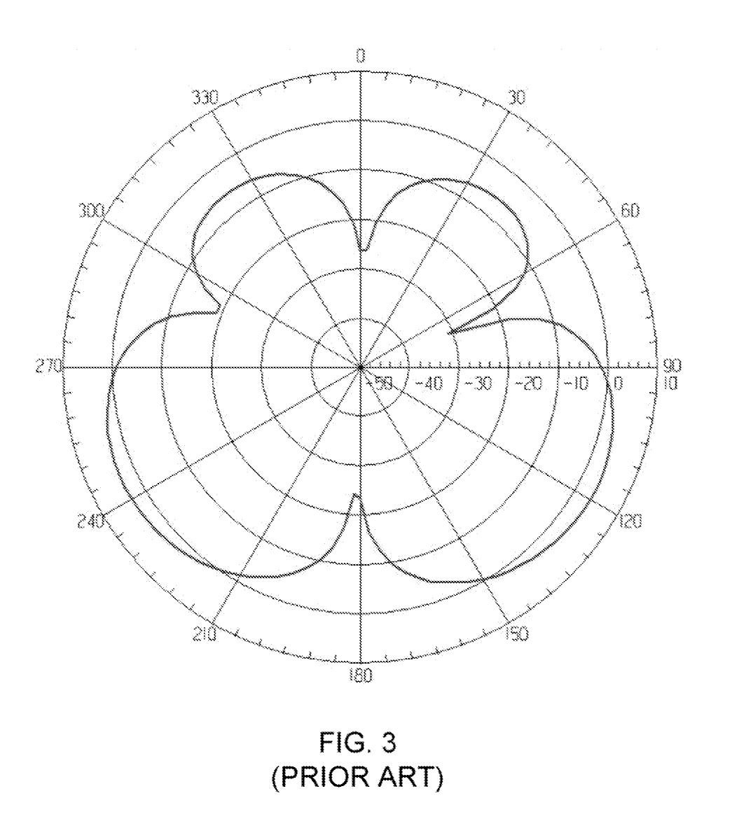

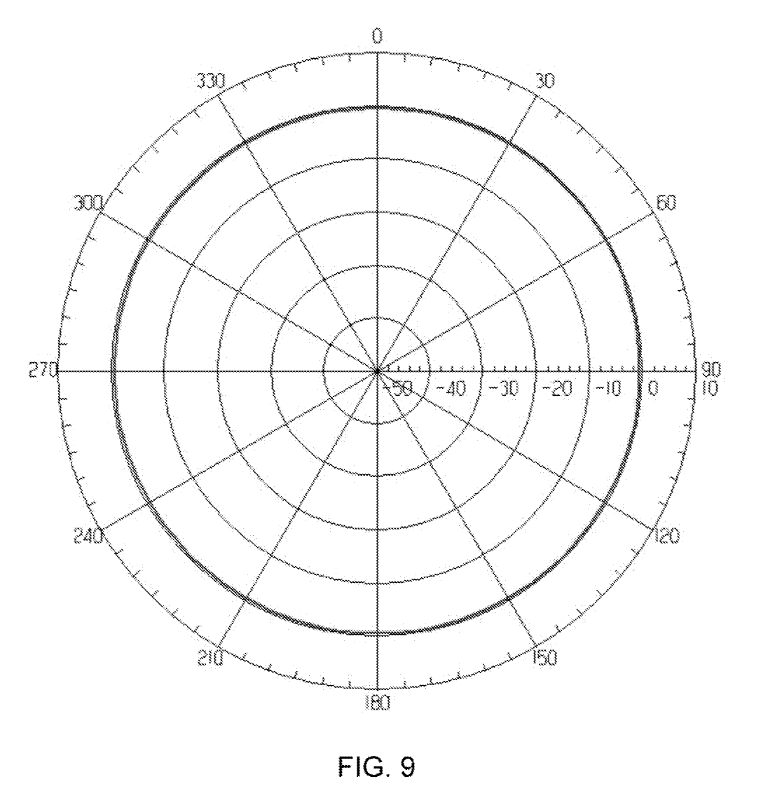

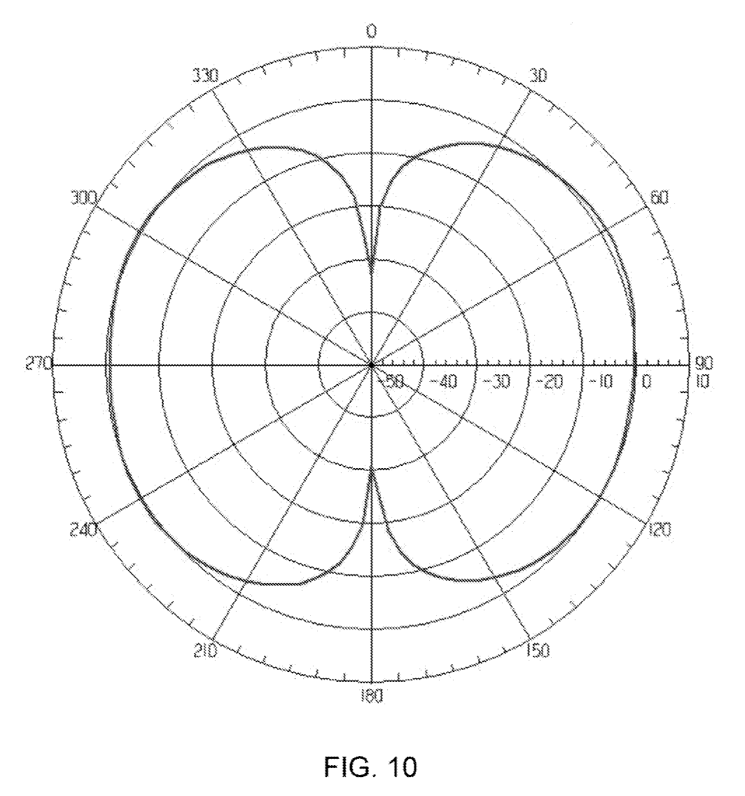

FIGS. 7 and 8 are magnitude-frequency diagrams with measured data of the return loss and the VSWR respectively. Next, proceed experimental tests of radiation pattern, at 2.45 GHz frequency and different planes. FIG. 9 is a radiation pattern diagram of the dipole antenna with reduced feedline reverse current according to the present invention with experimental data at 2.45 GHz, X-Y plane. FIG. 10 is a radiation pattern diagram of the dipole antenna with reduced feedline reverse current according to the present invention with experimental data at 2.45 GHz, Y-Z plane. Comparing the radiation patterns of FIG. 10 with FIG. 2, we can find it obvious that the two radiation patterns are almost identical. Since FIG. 2 is provided with experimental data at 2.45 GHz, Y-Z plane when no reverse current affects the dipole antenna, this diagram really illustrates an ideal radiation pattern it should be. Therefore, according to the comparison result between FIGS. 10 and 2, it is proved that the dipole antenna of the present invention is capable of reducing the reverse current generated by the feedline. So the radiation pattern of the present invention is almost as the same as the dipole antenna without effects from the reverse current.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A dipole antenna with reduced feedline reverse current, comprising:
a substrate, including a first surface, a second surface, and a feed aperture and a ground aperture both penetrating the first surface and the second surface;
a radiator configured on the first surface for receiving and transmitting wireless signals;
a feeder configured on the second surface, connecting with the radiator through the feed aperture;
a ground portion configured on the second surface, connecting with the radiator through the ground aperture, and having a main notch extending inwards from an edge of the second surface; and
a feedline passing through the main notch, with one end connecting with the feeder and the ground portion.

2. The dipole antenna of claim 1, wherein the feedline is a coaxial cable comprising:
a central conductor connecting to the feeder; and
an external ground conductor surrounding the central conductor and connecting with the ground portion.

3. The dipole antenna of claim 1, wherein the reverse current of the feedline is absorbed by the ground portion around the main notch.

4. The dipole antenna of claim 1, wherein the main notch is approximately rectangular.

5. The dipole antenna of claim 1, wherein the ground portion further comprises an auxiliary notch corresponsive to the radiator.

6. The dipole antenna of claim 1, wherein the radiator comprising:
a first radiation region with electrical length of quarter wavelength; and
a second radiation region with electrical length of quarter wavelength.

7. The dipole antenna of claim 6, wherein the first radiation region is T-shaped.

8. The dipole antenna of claim 6, wherein the second radiation region is approximately a reverse-U shape.

9. The dipole antenna of claim 1, wherein the radiator, the feeder and the ground portion are made of metal conductor with an overall input impedance of approximately 50 ohm.

10. A dipole antenna with reduced feedline reverse current, comprising:
a substrate, including a first surface, a second surface, and a feed aperture and a ground aperture both penetrating the first surface and the second surface;
a radiator configured on the first surface for receiving and transmitting wireless signals;
a feeder configured on the second surface, connecting with the radiator through the feed aperture;
a ground portion configured on the second surface, connecting with the radiator through the ground aperture, and having a main notch extending inwards from an edge of the second surface; and
a coaxial cable passing through the main notch, comprising:
a central conductor connecting to the feeder, a forward current flowing in the central conductor; and
a external ground conductor surrounding the central conductor and connecting with the ground portion, induced by the forward current to generate a reverse current, the reverse current being absorbed by the ground portion around the main notch.

11. The dipole antenna of claim 10, wherein the main notch is approximately rectangular.

12. The dipole antenna of claim 10, wherein the ground portion further comprises an auxiliary notch corresponsive to the radiator.

13. The dipole antenna of claim 10, wherein the radiator comprising:
a first radiation region with electrical length of quarter wavelength; and
a second radiation region with electrical length of quarter wavelength.

14. The dipole antenna of claim 13, wherein the first radiation region is T-shaped.

15. The dipole antenna of claim 13, wherein the second radiation region is approximately a reverse-U shape.

16. The dipole antenna of claim 10, wherein the radiator, the feeder and the ground portion are made of metal conductor with an overall input impedance of approximately 50 ohm.
